(19) United States
(12) Patent Application Publication
(10) Pub. No.: US 2017/0021645 A1
(43) Pub. Date: Jan. 26, 2017

(54) ROLLER FOR FEEDING AND CONVEYING PAPER SHEETS AND METHOD FOR PRODUCING THE ROLLER

(71) Applicant: SYNZTEC CO., LTD., Tokyo (JP)

(72) Inventors: Yuichi SHIBATA, Kanagawa (JP); Hiroki NAGAI, Kanagawa (JP)

(21) Appl. No.: 15/302,504

(22) PCT Filed: Aug. 5, 2015
(86) PCT No.: PCT/JP2015/072288

§ 371 Date: Oct. 7, 2016

(30) Foreign Application Priority Data
Aug. 7, 2014 (JP) 2014-161859

(51) Int. Cl. B41J 11/04; B65H 27/00

(52) U.S. Cl. CPC B41J 11/04; B65H 27/00; B65H 2404/114

(57) ABSTRACT

Disclosed is a paper-sheet-feeding/conveying roller having an elastic body 10 and a surface treatment layer 11 which has been formed by impregnating a surface portion 10a of the elastic body 10 with a treatment liquid containing an isocyanate compound and curing the liquid; and the micro hardness (Hs₁) of the surface treatment layer 11, the friction coefficient (μ₁) of the surface treatment layer 11, the micro hardness (Hs₂) of the elastic body 10 after removal of the surface treatment layer 11 and the friction coefficient (μ₂) of the elastic body 10 after removal of the surface treatment layer 11, the micro hardness values being determined by way of a micro hardness tester, satisfy the following relationships of formulas (1) and (2): 0<(Hs₁−Hs₂)/Hs₂≦17% (1) and |μ₁−μ₂|/μ₂<22% (2).

### TECHNICAL FIELD

The present invention relates to a roller for feeding or conveying a paper sheet (hereinafter referred to as a paper-sheet-feeding/conveying roller) and to a method for producing the roller.

### BACKGROUND ART

Conventionally, office automation (OA) apparatuses such as a copying machine and a printer are equipped with a paper-feeding mechanism for automatically conveying an object to be conveyed (hereinafter referred to as a conveyance object) such as a paper sheet. Such a paper-feeding mechanism has a paper-sheet-feeding/conveying roller made of an elastic body formed on a core, and a paper sheet is fed by means of the friction between the surface of the paper-sheet-feeding/conveying roller and the paper sheet during rotation of the roller. Therefore, the paper-sheet-feeding/conveying roller is required to have a suitable elasticity so that friction effectively generates between the paper sheet and the roller.

From another aspect, the paper-sheet-feeding/conveying roller should have excellent wear resistance. Through repeated friction against paper, the surface of the paper-sheet-feeding/conveying roller is gradually ground. In the case where the surface has been embossed, the embossment is gradually worn, whereby the conveyance performance of the roller is impaired. In order to solve this problem, there has been proposed a paper-conveying roller having a cured body (urethane elastomer) formed, on the surface of the core, by use of a urethane composition containing a polyisocyanate for producing a paper-conveying roller, the cured body having a hardness and a cross-linking density falling within specific ranges, respectively (see Patent Document 1).

### PRIOR ART DOCUMENTS

### Patent Documents

Patent Document 1: Japanese Patent No. 3692917

### SUMMARY OF THE INVENTION

### Problems to be Solved by the Invention

However, the paper-conveying roller of Patent Document 1, which has been provided so as to attain increased hardness of the cured body, has problematically reduced friction coefficient due to reduced elasticity, the problem being trade-off to with respect to high hardness. In this case, difficulty is encountered in ensuring a certain level of friction coefficient required for satisfactory roller products, thereby failing to realize suitable paper feeding performance. Thus, a drop in paper feeding efficiency, generation of squeaky sound (anomalous sound), paper conveyance failure, etc. are highly likely to occur.

The above problem is involved not only in paper-sheet-feeding/conveying rollers of a paper-feeding mechanism built in various OA apparatuses, but also in paper-sheet-feeding/conveying rollers of other paper-feeding apparatuses employing friction between a roller and a conveyance object (e.g., a bill changer, a cash depositing/dispensing machine, an automatic ticket gate, and an automatic ticketing machine). The same problem is also involved in a belt-type feeding means, a so-called paper-feeding belt.

In view of the foregoing, an object of the present invention is to provide a paper-sheet-feeding/conveying roller which can suppress wear of the surface of a conveyance object during conveyance thereof and which can prevent a considerable drop in friction coefficient. Another object is to provide a method for producing the roller.

### Means for Solving the Problems

In a first mode of the present invention for attaining the aforementioned objects, there is provided a paper-sheet-feeding/conveying roller, characterized in that the roller has an elastic body and a surface treatment layer which has been formed by impregnating a surface portion of the elastic body with a treatment liquid containing an isocyanate compound and curing the liquid; and the micro hardness (Hs₁) of the surface treatment layer, the friction coefficient (μ₁) of the surface treatment layer, the micro hardness (Hs₂) of the elastic body after removal of the surface treatment layer, and the friction coefficient (μ₂) of the elastic body after removal of the surface treatment layer, the micro hardness values being determined by means of a micro hardness tester, satisfy the following relationships of formulas (1) and (2):

0<(Hs₁−Hs₂)/Hs₂≦17% (1)

and

|μ₁−μ₂|/μ₂<22% (2).

According to the first mode, the hardness of the surface portion can be enhanced, and the percent increase in hardness does not exceed a predetermined upper limit, based on formula (1) above. Also, the percent decrease in friction coefficient is suppressed to be lower than a predetermined upper limit, based on formula (2) above. Thus, a paper-sheet-feeding/conveying roller having such properties can be provided, whereby wear of the surface of a conveyance object during conveyance thereof can be suppressed, and a considerable drop in friction coefficient can be prevented.

The aforementioned elastic body is preferably predominantly formed of a urethane material. Such an elastic body readily satisfies the aforementioned relationships of formulas (1) and (2). In addition, the above urethane material has high reactivity to an isocyanate compound, whereby the aforementioned paper-sheet-feeding/conveying roller can be readily provided.

The aforementioned elastic body preferably has an embossment. By virtue of such an embossment, the surface portion of the paper-sheet-feeding/conveying roller has resistance to abrasion which results in losing the embossment.

In a second mode of the present invention for attaining the aforementioned objects, there is provided a method for producing a paper-sheet-feeding/conveying roller, characterized in that the method comprises forming a surface treatment layer by impregnating a surface portion of an elastic body with a treatment liquid containing an isocyanate compound and curing the liquid, so that the surface treatment layer has a micro hardness (Hs₁) of the surface treatment layer, the friction coefficient (μ₁) of the surface treatment layer, the micro hardness (Hs₂) of the elastic body after removal of the surface treatment layer, and the friction coefficient (μ₂) of the elastic body after removal of the surface treatment layer, the micro hardness values being determined by means of a micro hardness tester, which satisfy the following relationships of formulas (1) and (2):

0<(Hs₁−Hs₂)/Hs₂≦17% (1)

and

|μ₁−μ₂/μ₂<22% (2).

According to the second mode, the hardness of the surface portion can be enhanced, and the percent increase in hardness does not exceed a predetermined upper limit, based on formula (1) above. Also, the percent decrease in friction coefficient is suppressed to be lower than a predetermined upper limit, based on formula (2) above. Thus, a paper-sheet-feeding/conveying roller having such properties can be provided, whereby wear of the surface of a conveyance object during conveyance thereof can be suppressed, and a considerable drop in friction coefficient can be prevented.

The aforementioned treatment liquid used in the invention preferably contains an isocyanate compound in an amount of 2.5 to 12.5 mass %. As a result, the aforementioned relationships of formulas (1) and (2) can be readily attained, to thereby readily produce the aforementioned paper-sheet-feeding/conveying roller.

### Effects of the Invention

According to the paper-sheet-feeding/conveying roller of the present invention and the production method therefor, wear of the surface of a conveyance object during conveyance thereof can be suppressed, and a considerable drop in friction coefficient can be prevented.

### BRIEF DESCRIPTION OF THE DRAWINGS

FIG. 1

Schematic views of a paper-sheet-feeding/conveying roller according to Embodiment 1.

FIG. 2

Schematic views of paper-sheet-feeding/conveying rollers according to Embodiments 2 and 3.

FIG. 3

A sketch of an apparatus for measuring of friction coefficient in Examples and Comparative Examples.

FIG. 4

A sketch of an apparatus for confirming resistance to disappearance of embossment in Examples and Comparative Examples.

### MODES FOR CARRYING OUT THE INVENTION

### Embodiment 1

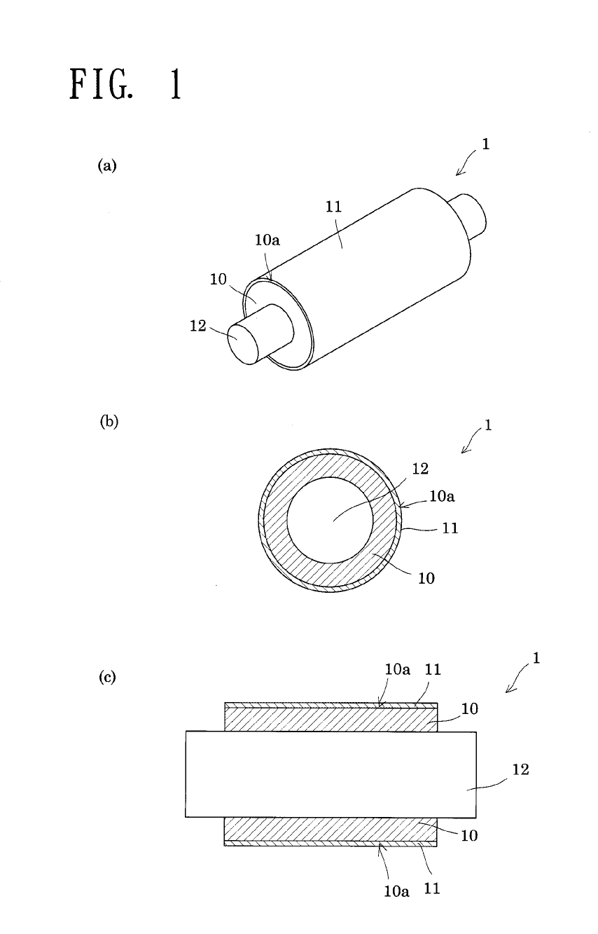

FIGS. 1(a) to 1(c) are views showing a paper-sheet-feeding/conveying roller according to Embodiment 1. FIG. 1(a) is a perspective view of the roller. FIG. 1(b) is a cross-sectional view of the roller cut along the direction orthogonal to the axis direction. FIG. 1(c) is a cross-sectional view of the roller cut along the axis direction.

A paper-sheet-feeding/conveying roller 1 according to Embodiment 1 has an elastic body 10 and a surface treatment layer 11 which has been formed by impregnating a surface portion 10a of the elastic body 10 with a treatment liquid containing an isocyanate compound and curing the liquid; and the micro hardness (Hs₁) of the surface treatment layer 11, the friction coefficient (μ₁) of the surface treatment layer 11, the micro hardness (Hs₂) of the elastic body 10 after removal of the surface treatment layer 11, and the friction coefficient (g₂) of the elastic body 10 after removal of the surface treatment layer, the micro hardness values being determined by means of a micro hardness tester, satisfy the following relationships of formulas (1) and (2):

[F1]

0<(Hs₁−Hs₂)/Hs₂17% (1)

and

[F2]

|μ₁−μ₂|/μ₂<22% (2).

The elastic body 10 is provided on a core 12. The core 12 serves as a rotation axis of the paper-sheet-feeding/conveying roller 1, with one or both ends thereof being sustained by another member or other members. The entirety or a part of the elastic body may be formed of any of a variety of metallic materials such as SUS and aluminum. However, within the scope of the present invention, no Particular limitation is imposed on the mode of the core 12 of Embodiment 1. The elastic body 10 may be integrally fixed to the surface of the core 12, or to the surface of the core 12 by the mediation of a bearing member detachable from the core 12. When the elastic body 10 is detachable from the core 12, replacement and maintenance of parts of the elastic body 10 may be readily carried out. Furthermore, a plurality of elastic bodies 10 may be disposed on one common core 12 at specific intervals.

The elastic body 10 has the surface portion 10a, on which the surface treatment layer 11 is formed. In Embodiment 1, the surface treatment layer 11 is formed on the entire surface of the elastic body 10. However, the surface treatment layer 11 may be formed at least on a part of the elastic body where friction is generated by contact with a paper sheet to be fed. Notably, the conveyance object is not limited to paper, and the paper-sheet-feeding/conveying roller 1 finds various conveyance uses within the scope of the present invention.

The surface treatment layer 11 is formed through a surface treatment (i.e., impregnating the surface portion 10a of the elastic body 10 with a specific treatment liquid containing an isocyanate compound and curing the liquid (hereinafter may be referred to simply as “surface treatment”)). The surface treatment layer 11 is formed so that the micro hardness (Hs₁) thereof and the micro hardness (Hs₀) of the elastic body 10 in a non-surface-treated state (before surface treatment) satisfy 0<(Hs₁−Hs₀)/Hs₀≦17%. In Embodiment 1, the surface portion 10a of the elastic body 10 is formed to have a smooth surface. Thus, the surface treatment layer 11 also has a smooth surface. In the case where the surface of the elastic body 10 has various irregularities such as embossments, the surface treatment layer 11 has a surface having irregularities.

Meanwhile, in the present specification, the relationship between the micro hardness (Hs₁) of the surface treatment layer 11 and the micro hardness (Hs₂) of the elastic body 10 after removal of the surface treatment layer 11 is defined by formula (1); and the relationship between the friction coefficient (μ₁) of the surface treatment layer 11, and the friction coefficient (μ²) of the elastic body 10 after removal of the surface treatment layer 11 is defined by formula (2). In evaluation of the micro hardness and the friction coefficient in formulas (1) and (2), the elastic body 10 in the non-surface-treated state (before surface treatment) is equivalent to the elastic body 10 after removal of the surface treatment layer 11 which has been subjected to the surface treatment.

In other words, “the elastic body after removal of the surface treatment layer” in the specification is obtained by polishing the surface portion 10a of the elastic body 10, which portion includes the formed surface treatment layer 11 until the elastic body is exposed. The micro hardness (Hs₂) and the friction coefficient (μ₂) of “the elastic body after removal of the surface treatment layer” can be substantially regarded as the micro hardness and the friction coefficient of the elastic body 10 in the non-surface-treated state (before surface treatment). In Embodiment 1, the coated roller is heated at about 100° C. for several minutes to some tens of minutes in a step of forming the surface treatment layer 11. The aforementioned concept may also apply to the states before and after carrying out such heating. Even though the heating is performed at a higher temperature for a longer time, the concept is applicable under the heating conditions generally employed in the art. Notably, the micro hardness and the friction coefficient are measured through techniques described in the Examples below.

According to formula (1), the difference (ΔHs; Hs₁−Hs₂) between the micro hardness (Hs₁) of the surface treatment layer 11 and the micro hardness (Hs₂) of the elastic body 10 after removal of the surface treatment layer 11 is greater than 0. The condition indicates that the hardness of the surface portion 10a of the paper-sheet-feeding/conveying roller 1 has been enhanced by the surface treatment. Such an enhanced hardness is advantageous in realizing suitable paper feeding (e.g., enhancement in paper feed efficiency).

Also, according to formula (1), the relative value of the difference (ΔHs; Hs₁−Hs₂) between the micro hardness (Hs₁) of the surface treatment layer 11 and the micro hardness (Hs₂) of the elastic body 10 after removal of the surface treatment layer 11 is 17% or less. The condition indicates that the percent rise in hardness of the surface portion 10a of the paper-sheet-feeding/conveying roller 1 does not increase excessively. Thus, the friction between the roller and the conveyance object decreases, whereby undesired conditions in realizing suitable paper feeding can be avoided. In Embodiment 1, an excessive rise in hardness of the surface portion 10a of the paper-sheet-feeding/conveying roller 1 can be prevented. This leads to prevention of an excessive rise in hardness of the surface treatment layer 11, in consideration of the elasticity of the elastic body 10 (represented by “product hardness” in Examples).

Therefore, formula (1) is preferably the following formula (1a):

[F1a]

2.0%≦(Hs₁−Hs₂)/Hs₂≦14% (1a).

Thus, when the relative value of the difference (ΔHs; Hs₁−Hs₂) between the micro hardness (Hs₁) of the surface treatment layer 11 and the micro hardness (Hs₂) of the elastic body 10 after removal of the surface treatment layer 11 falls within the aforementioned range, the hardness of surface treatment layer 11 increases, and a considerable drop in elasticity of the layer can be prevented.

According to formula (2), the ratio of the difference (absolute value) (|μ|; |μ₁−μ₂|) between the friction coefficient (μ₁) of the surface treatment layer 11 and the friction coefficient (μ₂) of the elastic body 10 after removal of the surface treatment layer 11 to the friction coefficient (μ₂) of the elastic body 10 after removal of the surface treatment layer 11 is less than 22%. The condition indicates that, according to formula (1), the hardness of the surface treatment layer 11 can be enhanced, while the percent drop in friction coefficient is controlled to be lower than a specific upper limit.

Therefore, formula (2) is preferably the following formula (2a):

[F2a]

|μ₁−μ₂|/μ₂≦14% (2a).

Thus, when the ratio of the difference (absolute value) (|μ|; |μ₁−μ₂|) between the friction coefficient (μ₁) of the surface treatment layer 11 and the friction coefficient (μ₂) of the elastic body 10 after removal of the surface treatment layer 11 to the friction coefficient (μ₂) of the elastic body 10 after removal of the surface treatment layer 11 falls within the aforementioned range, a friction coefficient of a specific level required for actual products can be maintained. This leads to reduction in the Possibility of occurrence of a drop in paper feeding efficiency, generation of squeaky sound (anomalous sound), paper conveyance failure, etc.

Notably, the aforementioned difference (Δμ) in formula (2) is provided as an absolute value, for preventing obtainment of a negative calculated value. Depending on the surface treatment conditions, the friction coefficient (μ₁) of the surface treatment layer 11 would remain equivalent to the friction coefficient (μ₂) of the elastic body 10 after removal of the surface treatment layer 11. In consideration of this situation, the absolute value is employed. Actually, as described in the Examples hereinbelow, there have been some cases in which the friction coefficient (μ₁) of the surface treatment layer 11 has been maintained to be equivalent to the friction coefficient of the untreated elastic body 10 (before surface treatment).

The aforementioned surface treatment layer 11 has a thickness, for example, of 10 μm or more, although the thickness should vary depending on the use of the paper-sheet-feeding/conveying roller 1. The surface treatment layer 11 having a small thickness can be formed in the surface portion 10a of the elastic body 10, by use of a treatment liquid prepared so as to have high affinity with the elastic body 10. Such a treatment liquid having high affinity with the elastic body 10 smoothly enters into the elastic body 10, and an excessive amount of the treatment liquid does not remain in the surface portion 10a of the elastic body 10. As a result, the production method of the invention does not need a step of removing an excessive amount of an isocyanate compound.

The treatment liquid for forming the surface treatment layer 11 contains an isocyanate compound and an organic solvent. Examples of the isocyanate compound include isocyanate compounds such as tolyiene diisocyanate (TDI), 4,4′-diphenylmethane diisocyanate (MDI), p-phenylene diisocyanate (PPDI), naphthalene diisocyanate (NDI), and 3,3′-dimethylbiphenyl-4,4′-diyl diisocyanate (TODI), and oligomers and modified products thereof.

Such a treatment liquid employed in the invention is preferably a mixed solution of an isocyanate compound, a polyol, and an organic solvent, or a mixed solution of an isocyanate-group-having (i.e., an isocyanate-terminated) compound (i.e., an isocyanate-group-having prepolymer), which is obtained through reaction between an isocyanate compound, and a polyol, and an organic solvent. Among these treatment liquids, a mixed solution of a bi-functional isocyanate compound, a tri-functional polyol, and an organic solvent; and a mixed solution of an isocyanate-group-having prepolymer obtained through reaction of a bi-functional isocyanate compound and a tri-functional polyol, and an organic solvent are more preferred. In the case where a mixed solution of a bi-functional isocyanate compound, a tri-functional polyol, and an organic solvent is used, the bi-functional isocyanate compound reacts with the tri-functional polyol, to thereby form an isocyanate-group-having prepolymer having an isocyanate group at an end thereof, in the step of impregnating the surface portion 10a of the elastic body 10 with the treatment liquid. Then, the liquid is cured and reacts with the elastic body 10.

In addition to the aforementioned characteristics, the surface treatment layer 11 which has been formed by use of a treatment liquid providing an isocyanate-group-having prepolymer via reaction between a bi-functional isocyanate compound and a tri-functional polyol, or by use of a treatment liquid containing an isocyanate-group-having prepolymer exhibits low friction and high hardness, even the layer is thin. Also, the layer exhibits excellent chipping resistance, filming resistance, and cleaning performance. Notably, the treatment liquid may be appropriately chosen in consideration of wettability to the elastic body 10, the extent of immersion, and the pot-life of the treatment liquid.

Examples of the bi-functional isocyanate compound include 4,4′-diphenylmethane diisocyanate (MDI), isophrone diisocyanate (IPDI), 4,4′-dicyclohexylmethane diisocyanate (H-MDI), trimethylhexamethylene diisocyanate (TMHDI), tolylene diisocyanate (TDI), carbodiimide-modified MDT, polymethylene polyphenyl polyisocyanate, 3,3′-dimethylbiphenyl-4,4′-diyl diisocyanate (TODI), naphthylene diisocyanate (MDI), xylene diisocyanate (XDI), lysine diisocyanate methyl ester (LDI), and dimethyl diisocyanate, and oligomers and modified products thereof. Among these bi-functional isocyanate compounds, those having a molecular weight of 200 to 300 are preferably used. Of these, 4,4′-diphenylmethane diisocyanate (MDI), 3,3′-dimethylbiphenyl-4,4′-diyl diisocyanate (TODI), etc. are preferred.

Particularly, the elastic body 10 employed in Embodiment 1 is mainly formed of a urethane material. In the present invention, the elastic body 10 mainly formed of a urethane material is, for example, an elastic body 10 containing a urethane material in an amount of 90 mass % or more, preferably 95 mass % or more. When such a polyurethane is used as the elastic body 10, high affinity can be attained between the hi-functional isocyanate compound and the polyurethane, whereby the surface treatment layer 11 is more effectively integrated to the elastic body 10. The elastic body 10 may further contain other components such as a chain-extender and a cross-linking agent.

Examples of the tri-functional polyol include tri-functional aliphatic polyols such as glycerin, 1,2,4-butanetriol, trimethylolethane (TME), trimethylolpropane (TMP), and 1,2,6-hexanetriol; polyether triols such as adducts of a tri-functional aliphatic polyol with ethylene oxide, butylene oxide, etc.; and polyester triols such as adducts of a tri-functional aliphatic polyol with a lactone or the like. Among these tri-functional polyols, those having a molecular weight of 150 or less are preferably used. Of these, trimethylolpropane (TMP) is preferred. When a tri-functional polyol having a molecular weight of 150 or less is used, high reaction rate can be attained between the polyol and isocyanate, whereby a high-hardness surface treatment layer can be formed. In addition, when the treatment liquid contains a tri-functional polyol, hydroxyl groups of the tri-functional react with isocyanate groups, to thereby yield the surface treatment layer 11 having a 3-dimenional structure with high cross-linking density.

No particular limitation is imposed on the organic solvent, so long as the solvent can dissolve the isocyanate compound and the polyol. An organic solvent having no active hydrogen, which can react with the isocyanate compound, is suitably used. Examples of the organic solvent include methyl ethyl ketone (MEK), methyl isobutyl ketone (MIBK), tetrahydrofuran (THE), acetone, ethyl acetate, butyl acetate, toluene, and xylene. The lower the boiling point of the organic solvent, the higher the dissolvability. In this case, the impregnation product can be rapidly dried, to thereby accomplish uniform surface treatment. Notably, the organic solvent is appropriately selected from these organic solvents, in consideration of the degree of swelling of the elastic body 10. Methyl ethyl ketone (MEK), acetone, and ethyl acetate are preferably used.

Also, the elastic body 10 is formed of a matrix containing active hydrogen. Examples of the matrix containing active hydrogen include polyurethanes mainly formed of the aforementioned urethane materials. Other examples of the matrix containing active hydrogen include matrices based on a rubber material such as epichlorohydrin rubber, nitrile rubber (NBR), natural rubber, isoprene rubber, styrene rubber (SBR), styrene-butadiene rubber, butadiene rubber, chloroprene rubber, fluororubber, chlorinated polyethylene rubber, acrylic rubber, or ethylene-propylene-diene rubber (EPDM). Among them, a polyurethane is preferred, by virtue of high reactivity to an isocyanate compound.

Examples of the rubber base formed of polyurethane include those mainly formed of at least one species selected from among aliphatic polyether, aliphatic polyester, and aliphatic polycarbonate. More specifically, such a rubber base formed of polyurethane is a reaction product of a polyol mainly containing at least one species selected from among aliphatic polyether, aliphatic polyester, and aliphatic polycarbonate, having a urethane bond. Examples of preferred polyurethane include polyether-based polyurethane, polyester-based polyurethane, and polycarbonate-based polyurethane. Alternatively, similar elastic bodies formed via a polyamide bond, an ester bond, or the like, instead of a urethane bond, may also be used. Yet alternatively, thermoplastic elastomers such as polyether-amide and polyether-ester may also be used. A rubber base having active hydrogen may also be used in combination, or a filler or a plasticizer each having active hydrogen may be used.

Through impregnating the surface portion 10a of the elastic body 10 with the treatment liquid and curing the liquid, the surface treatment layer 11 of Embodiment 1 is formed. The treatment liquid used in Embodiment 1 preferably has an isocyanate compound content of 2.5 to 12.5 mass %, more preferably 2.5 to 10.0 mass %. Based on such isocyanate compound content, the aforementioned relationships of formulas (1) and (2) can be readily attained.

In other words, the parameters of the aforementioned relationships of formulas (1) and (2) regarding the paper-sheet-feeding/conveying roller 1 are controlled by modifying the components of the specific treatment liquid containing an isocyanate compound. As shown in the Examples hereinbelow, the present invention foresees to increase the hardness of the surface portion 10a of the paper-sheet-feeding/conveying roller 1, to prevent an excessive percent rise in hardness over the upper limit, and to prevent a considerable drop in friction coefficient. Accordingly, by preparing a specific treatment liquid, and forming, through the surface treatment, the surface treatment layer 11 only on the surface portion 10a of the elastic body 10, these purposes can be attained.

No particular limitation is imposed on the method of impregnating the surface portion 10a of the elastic body 10 with such a treatment liquid and curing the liquid. In one mode of the method, the elastic body 10 is immersed in the treatment liquid, and heating the thus-treated elastic body. In another mode, the treatment liquid is applied onto the surface portion 10a of the elastic body 10 through spraying or a similar technique so as to impregnate the elastic body with the liquid, and subsequent heating is performed. No particular limitation is imposed on the heating method, and thermal treatment, forced drying, drying in ambient conditions, etc. may be employed.

Specifically, when a mixed solution containing an isocyanate compound, a polyol, and an organic solvent is used as the treatment liquid, the isocyanate compound reacts with the polyol, to thereby form a prepolymer, and the liquid is cured, during impregnation of the surface portion 10a of the elastic body 10 with the treatment liquid. In parallel, isocyanate groups are reacted with the elastic body 10. Through such a mechanism, the surface treatment layer Ii is formed.

When a prepolymer is used as the treatment liquid, the isocyanate compound and the polyol present in the treatment liquid are allowed to react in advance under specific conditions, to thereby convert the treatment liquid into a prepolymer having an isocyanate end group. The surface Portion 10a of the elastic body 10 is impregnated with the treatment liquid, and the liquid is cured. In parallel, isocyanate groups are reacted with the elastic body 10. Through such a mechanism, the surface treatment layer 11 is formed. The aforementioned formation of prepolymer between isocyanate compound and polyol may occur during impregnation of the surface portion 10a of the elastic body 10 with the treatment liquid. Thus, formation of the prepolymer can be regulated by adjusting the extent of reaction, reaction temperature and time, and circumstance of reaction, etc. Preferably, the reaction is performed at a treatment liquid temperature of 5° C. to 35° C. and a humidity of 20% to 70%. Notably, if needed, the treatment liquid may further contain a cross-linking agent, a catalyst, a curing agent, etc.

The aforementioned method for producing the paper-sheet-feeding/conveying roller 1 includes preparing a treatment liquid containing an isocyanate compound so as to satisfy the aforementioned relationships of formulas (1) and (2); impregnating the surface portion 12a of the elastic body 10 with the treatment solution, and curing the solution, to thereby form the surface treatment layer 11.

According to Embodiment 1, friction of the surface portion 10a during conveyance of the object can be reduced, and a considerable drop in friction coefficient can be prevented.

### Embodiment 2

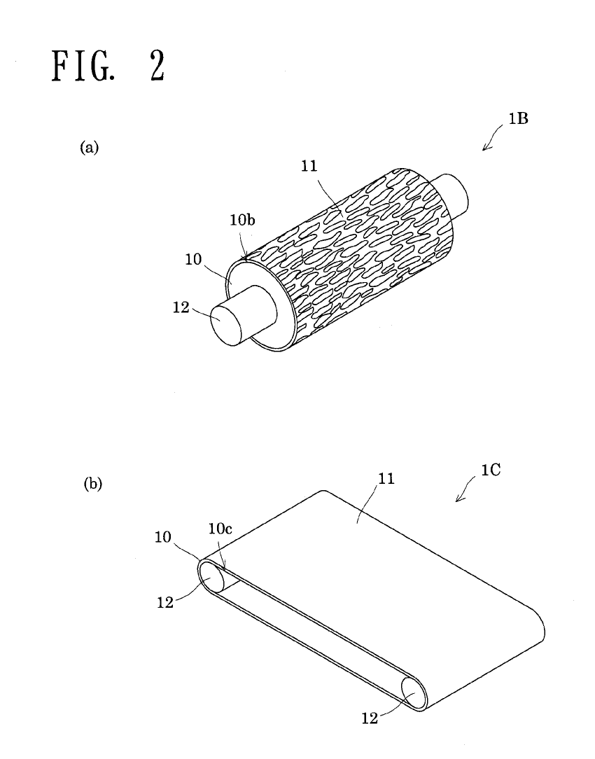

FIG. 2(a) shows an example of the paper-sheet-feeding/conveying roller according to Embodiment 2 of the present invention. A paper-sheet-feeding/conveying roller IF of Embodiment 2 has an embossed surface portion 10b of an eleatic body 10. Embodiment 2 differs from Embodiment 1 in that a surface treatment layer 11 is formed on the embossed surface portion 10b.

No particular limitation is imposed on the pattern mode and disposition area of embossment, within the scope of the present invention. For example, random irregularities may be disposed at least on the area to be come into contact with a conveyance object. The embossment can effectively suppress a reduction in conveyance performance, which would otherwise be caused by powdered paper and foreign matter. By virtue of the embossment, a step of surface-polishing the elastic body 10 may be omitted. However, in the case of the embossed paper-sheet-feeding/conveying roller 1B, the friction between the conveyance object and the roller is focused on the embossment during paper feeding, and the embossment may be gradually worn by repeated friction between the conveyance object and the roller.

In contrast, according to Embodiment 2, wear of the surface portion 10b during conveyance can be suppressed, and a considerable drop in friction coefficient can be prevented, whereby wear of the embossment by repeated friction between the conveyance object and the roller can be reduced. The degree of prevention of wear of embossment can be visually checked as shown in the Examples.

### Embodiment 3

FIG. 2(b) shows an example of the paper-sheet-feeding/conveying roller according to Embodiment 3 of the present invention. A characteristic feature of a paper-sheet-feeding/conveying roller 1C of Embodiment 3 resides in a difference from Embodiment 1 in that the roller is formed as a paper-sheet-feeding belt.

In Embodiment 3, an elastic body 10 in the form of an endless belt is disposed on a plurality of cores 12 such that the belt lies along the direction orthogonal to the core axis direction. The elastic body 10 serving as an endless belt has a surface portion 10c, and a surface treatment layer 11 formed on the surface portion 10c. Thus, according to Embodiment 3, wear of the surface portion 10c during conveyance can be suppressed, and a considerable drop in friction coefficient can be prevented.

### EXAMPLES

The present invention will next be described in detail by way of examples, which should not be construed as limiting the invention thereto.

### Example 1

### Production of Elastic Body

An elastic body 10 was formed on a core 12 through the following procedure. Specifically, a plasticizer RS107 (product of ADEKA) (15 parts by mass) was added to polyester polyol (number average molecular weight: 2,000) (100 parts by mass). To this mixture, MDI, 1,3-propanediol serving as a chain-extender, and triol P-3403 (product of Daicel Corp., number average molecular weight: 4,000) serving as a cross-linking agent were added. The resultant mixture was stirred at 70° C. for 3 minutes and then molded by a metal mold at 120° C., to thereby produce the elastic body 10.

Through the above procedure, a rubber roller was obtained. The roller was employed as an untreated paper-sheet-feeding/conveying roller.

### Preparation of Treatment Liquid

Diphenylethane isocyanate (MDT) (product of Nippon Polyurethane Industry, Ltd., molecular weight: 250.25) (3.8 parts by mass), TMP (product of Nippon Polyurethane Industry, Ltd., molecular weight: 134.17) (1.3 parts by mass), and methyl ethyl ketone (MEK) (95 parts by mass) were mixed, to thereby prepare a 5% treatment liquid.

### Surface Treatment of Elastic Body

The elastic body 10 was immersed for 60 seconds in the treatment liquid maintained at 23° C. and then heated for 30 minutes in an oven maintained at 100° C. Thereafter, the thus-treated elastic body 10 was bonded to the core 12, to thereby yield the paper-sheet-feeding/conveying roller 1 of Embodiment 1 having the surface treatment layer 11.

### Examples 2 to 4

The procedure of Example 1 was repeated, except that the isocyanate compound concentration of the treatment liquid was changed to the values shown in Table 1 and falling within the scope of the invention, to thereby yield the paper-sheet-feeding/conveying roller 1.

### Comparative Example 1

The procedure of Example 1 was repeated, except that no isocyanate compound was added to the treatment liquid, and no surface treatment was conducted, to thereby yield a paper-sheet-feeding/conveying roller.

### Comparative Example 2

The procedure of Example 1 was repeated, except that the isocyanate compound concentration of the treatment liquid was excessively increased, to thereby yield a paper-sheet-feeding/conveying roller.

### Test Example 1 <Measurement of Hardness of Roller Products>

Hardness of each of the paper-sheet-feeding/conveying roller products of Examples 1 to 4 and Comparative Examples 1 to 3 was measured at a surface portion thereof by means of a type-A durometer. Not that this hardness of the product was attributed not only to the surface portion but also to elasticity of the elastic body 10 present under the surface portion.

### Test Example 2 <Measurement of Micro Hardness (Hs)>

Hardness (Hs) of each of the paper-sheet-feeding/conveying rollers of Examples 1 to 4 and Comparative Examples 1 and 2 was measured at a surface portion thereof by means of a micro hardness tester (MD-1, product of Kobunshi Keiki Co., Ltd.). The percent rise (%) in micro hardness ((Hs₁−Hs₂)/Hs₂) between the micro hardness (Hs₁) of the surface portion and the micro hardness (Hs₂) of the elastic body 10 after removal of the surface portion was determined. The micro hardness (Hs₂) of the elastic body 10 after removal of the surface portion employed in Test Example 2 was the micro hardness of the paper-sheet-feeding/conveying roller of Comparative Example 1. Tables 1 and 2 show the results.

### Test Example 3 <Measurement of Friction Coefficient (μ)>

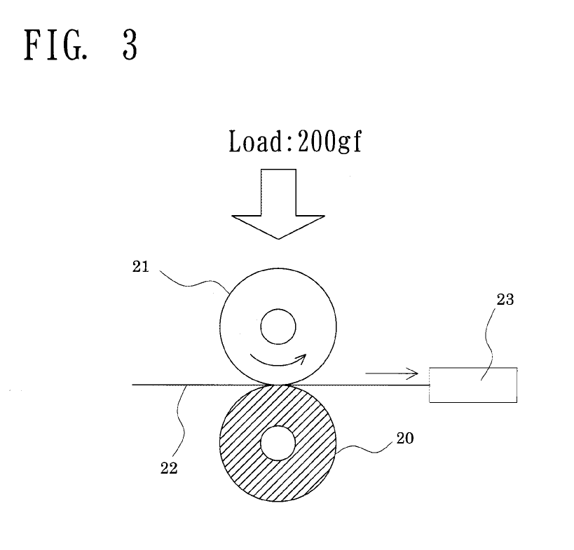

Friction coefficient of each of the paper-sheet-feeding/conveying rollers of Examples 1 to 4 and Comparative Examples 1 and 2 was measured. The friction coefficient was determined as shown in FIG. 3. Specifically, each paper-sheet-feeding/conveying roller 20 was pressed against a rotatable free-roller 21 at a load of 200 gf so as to sandwich a paper sheet 22 therebetween. One end of the paper sheet 22 was connected to a load cell 23. When the paper sheet 22 was pulled by means of the load cell 23, the load Q (N) was measured, and the friction coefficient was determined by the following formula (3). The paper sheet 22 employed in Text Example 3 was TYPE-6200 (product of RICOH) and was fed at a speed of 50 mm/sec. The test was performed under ambient temperature/moisture conditions (NN: 23° C.×55% RH). Tables 1 and 2 show the results.

[F3]

μ=Q(N)/(200 gf×0.0098) (3)

Also, the percent drop (%) in friction coefficient (|μ₁−μ₂|/μ₂) between the friction coefficient (μ₁) of the surface portion and the friction coefficient (μ₂) of the elastic body 10 after removal of the surface portion was determined for each of the paper-sheet-feeding/conveying rollers of Examples 1 to 4 and Comparative Examples 1 and 2. The friction coefficient (μ₂) of the elastic body 10 after removal of the surface portion employed in this test was that of the paper-sheet-feeding/conveying roller of Comparative Example 1. Table 1 shows the results.

### Test Example 4 <Wear Test>

Each of the paper-sheet-feeding/conveying rollers of Examples 1 to 4 and Comparative Examples 1 and 2 was subjected to a Taber abrasion test by means of a “rotary abrasion tester” (product of Toyo Seiki Seisaku-Sho, Ltd.) in accordance with JIS K 6264-2. The rotary disk was rotated at 60±2/minutes with application force of 9.8 N (2,000 continuous rotations). A grinding wheel of H22 was employed. The percent change in mass (%) was calculated by the following formula (4).

[F4]

Percent mass change (%)=(mass of elastic body before test/mass of elastic body after test)×100 (4)

### Test Example 5 <Generation of Squeaky Sound>

Generation of squeaky sound was checked for each of the paper-sheet-feeding/conveying rollers of Examples 1 to 4 and Comparative Examples 1 and 2, as shown in FIG. 3. Specifically, each paper-sheet-feeding/conveying roller 20 was pressed against a rotatable free-roller 21 at a load of 200 gf so as to sandwich a paper sheet 22 therebetween. One end of the paper sheet 22 was connected to the load cell 23. When the paper sheet 22 was pulled, generation of squeaky sound was checked. The paper sheet 22 employed in Test Example 5 was TYPE-6200 (product of RICOH) and was fed at a speed of 50 mm/sec. The test was performed under ambient temperature/moisture conditions (NN: 23° C.×55%RH). The case of no squeaky sound generation is denoted by “O,” and the case of a squeaky sound generation is denoted by “X.”

TABLE 1

| | | | | | | Comp. | Comp. |
|---|---|---|---|---|---|---|---|
| | | Ex. 1 | Ex. 2 | Ex. 3 | Ex. 4 | Ex. 1 | Ex. 2 |
| Surface | Concentration | 2.5 | 5.0 | 7.5 | 12.5 | 0 | 17.5 |
| treatment | (mass%) | | | | | | |
| Diam. | Outer diam. (mm)/ | 20.26/ | 20.28/ | 20.22/ | 20.26/ | 20.22/ | 20.27/ |
| | Inner diam. (mm) | 12 | 12 | 12 | 12 | 12 | 12 |
| Hardness | Product hardness (°) | 45.0 | 46.3 | 46.9 | 47.6 | 46.3 | 49.0 |
| | Micro hardness (°) | 42.3 | 44.6 | 45.7 | 46.0 | 40.1 | 48.4 |
| Paper feed | Friction coefficient | 1.90 | 1.94 | 1.84 | 1.53 | 1.94 | 1.51 |
| | Squeaky sound | ◯ | ◯ | ◯ | X | ◯ | X |

| | | | | | | |
|---|---|---|---|---|---|---|
| Wear test (%) | 1.4 | 1.2 | 1.1 | — | 1.6 | — |

TABLE 2

| | | | | | | Comp. | Comp. |
|---|---|---|---|---|---|---|---|
| | | Ex. 1 | Ex. 2 | Ex. 3 | Ex. 4 | Ex. 1 | Ex. 2 |
| Micro | Surface treatment | 42.3 | 44.6 | 45.7 | 46.0 | 40.1 | 48.4 |
| hardness (°) | layer Hs₁ | | | | | | |
| | Elastic body after | 40.1 | 40.1 | 40.1 | 40.1 | 40.1 | 40.1 |
| | removal of surface | | | | | | |
| | treatment layer Hs₂ | | | | | | |
| | Difference | 2.2 | 4.5 | 5.6 | 5.9 | 0 | 7.3 |
| | Hs₁ − Hs₂ | | | | | | |
| | % Hardness rise | 5.5% | 11.2% | 14.0% | 14.7% | 0% | 18.2% |
| | (Hs₁ − Hs₂)/Hs₂ | | | | | | |
| Friction coeff. | Surface treatment | 1.90 | 1.94 | 1.84 | 1.53 | 1.94 | 1.51 |
| (μ) | layer μ₁ | | | | | | |
| | Elastic body after | 1.94 | 1.94 | 1.94 | 1.94 | 1.94 | 1.94 |
| | removal of surface | | | | | | |
| | treatment layer μ₂ | | | | | | |
| | Absolute difference | 0.04 | 0 | 0.10 | 0.41 | 0 | 0.43 |
| | \|μ₁ − μ₂\| | | | | | | |
| | % Drop in friction | 2.01% | 0% | 5.15% | 21.2% | 0% | 22.2% |
| | coeff. \|μ₁ − μ₂\|/μ2 | | | | | | |

As shown in Table 2, Examples 1 to 4 exhibited a relative value of the difference (ΔHs; Hs₁−Hs₂) between the micro hardness (Hs₁) of the surface treatment layer 11 and the micro hardness (Hs₂) of the elastic body 10 after removal of the surface treatment layer 11 of 17% or less. In other words, through the surface treatment of the present invention, the rise in micro hardness was suppressed to 14% or lower in Examples 1 to 3. Thus, when the untreated paper-sheet-feeding/conveying roller (Comparative Example 1; micro hardness of 40.1) was subjected to the surface treatment of the invention, the hardness of the surface portion was enhanced, and exceeding the percent rise in hardness over a specific value was prevented.

In contrast, in Comparative Example 2, where the isocyanate concentration of the treatment liquid was excessively high, the percent rise in micro hardness after the surface treatment was in excess of 17%.

Next, as shown in Table 2, Examples 1 to 4 exhibited a ratio of the difference (absolute value) (|Δμ|; |μ₁−μ₂|) between the friction coefficient (μ₁) of the surface treatment layer 11 and the friction coefficient (μ₂) of the elastic body 10 after removal of the surface treatment layer 11 to the friction coefficient (μ₂) of the elastic body 10 after removal of the surface treatment layer 11 was smaller than 22%. In Examples 1 to 3, the ratio was suppressed to 14% or lower. Specifically, after the completion of the surface treatment, the percent drop in friction coefficient was suppressed to lower than 22%. Thus, when the untreated paper-sheet-feeding/conveying roller (Comparative Example 1; micro hardness of 40.1) was subjected to the surface treatment of the invention, a considerable drop in friction coefficient was prevented, while the hardness of the surface was increased.

In contrast, in Comparative Example 2, where the isocyanate compound concentration of the treatment liquid was excessively high, the percent drop in friction coefficient after the surface treatment was higher than 22%.

As shown in Table 2, along with the test results of product hardness shown in Table 1, an excessive rise in product hardness of the surface treatment layer 11 after the surface treatment, in consideration of the elasticity of the elastic body 10, was found to be prevented.

As shown in Table 1 (Wear test), in Examples 1 to 4, the wear was suppressed to 1.5% or less, or 1.4% or less. However, in Comparative Example 1, a wear amount of 1.6% or greater was observed.

Furthermore, as shown in Table 1 (Squeaky sound), no squeaky sound was observed particularly in Examples 1 to 3. Thus, suitable paper feeding was thought to be realized. Accordingly, under such circumstances, a drop in paper feed efficiency, paper conveyance failure, etc. are conceivably prevented at a high likelihood.

### Examples 1a to 4a

The procedures of Examples 1 to 4 were repeated, except that an embossed surface portion as described in Embodiment 2 was employed, to thereby produce paper-sheet-feeding/conveying rollers.

### Comparative Examples 1b and 2b

The procedures of Comparative Examples 1 and 2 were repeated, except that a similar surface portion was employed, to thereby produce paper-sheet-feeding/conveying rollers.

### Test Example 6 <Wear Resistance of Embossment>

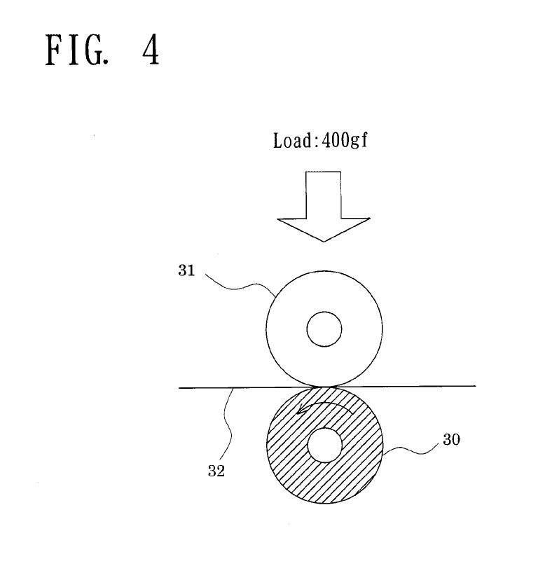

Each of the paper-sheet-feeding/conveying rollers of Examples 1a to 4a and Comparative Examples 1b and 2b was tested, as shown in FIG. 4. Specifically, each paper-sheet-feeding/conveying roller 30 was pressed against a rotatable free-roller 31 at a load of 400 gf so as to sandwich an abrasive cloth 32 (Abrasive cloth A-400: product of KOYO-SHA Co., Ltd.) fixed to the roller. The paper-sheet-feeding/conveying roller 30 was rotated (30,000 rotations at a rotation speed of 500 rpm). Thereafter, the surface portion of the paper-sheet-feeding/conveying roller 30 was visually observed. As a result, the case where the embossment is assessed to be maintained is denoted by “O,” and the case where the embossment is assessed to be changed (i.e., the embossment is removed by friction) is denoted by “X.” Table 3 shows the results.

TABLE 3

| | | | | | Comp. | Comp. |
|---|---|---|---|---|---|---|
| | Ex. 1a | Ex. 2a | Ex. 3a | Ex. 4a | Ex. 1b | Ex. 2b |
| Embossment | ◯ | ◯ | ◯ | ◯ | X | ◯ |

As is clear from Table 3, the embossment of each of the paper-sheet-feeding/conveying rollers of Examples 1a to 4a exhibited wear resistance. In contrast, as observed in Test Examples 1 to 5, the hardness of the surface portion was not enhanced in Comparative Example 1b. Thus, the embossment disappeared through repeated friction with the paper sheet.

As described above, the embodiments represented by Examples 1 to 4 and Examples 1a to 4a exhibited suppressed wear of the surface portion during conveyance thereof. In these embodiments, a considerable drop in friction coefficient was found to be prevented.

### Industrial Applicability

The paper-sheet-feeding/conveying roller of the present invention and the production method therefor can be applied not only to paper-sheet-feeding/conveying rollers of a paper-feeding mechanism built in various OA apparatuses, but also to paper-sheet-feeding/conveying rollers of other paper-feeding apparatuses employing friction between a roller and a conveyance object (e.g., a bill changer, a cash depositing/dispensing machine, an automatic ticket gate, and an automatic ticketing machine). The invention is also applicable to a so-called paper-feeding belt. No particular limitation is imposed on the conveyance object to a paper sheet, and various objects may be conveyed, within the scope of the present invention.

### Description of the Reference Numerals

1, 1B, C: paper-sheet-feeding/conveying roller; 10: elastic body; 10a, 10b, 100: surface portion; 11: surface treatment layer; 12: core; 20: paper-sheet-feeding/conveying roller; 21: free roller; 22: paper sheet; 23: load cell; 30: paper-sheet-feeding/conveying roller; 31: free roller; and 32: abrasive cloth

1. A paper-sheet-feeding/conveying roller, characterized in that the roller has an elastic body and a surface treatment layer which has been formed by impregnating a surface portion of the elastic body with a treatment liquid containing an isocyanate compound and curing the liquid; and
the micro hardness (Hs₁) of the surface treatment layer, the friction coefficient (μ₁) of the surface treatment layer, the micro hardness (Hs₂) of the elastic body after removal of the surface treatment layer, and the friction coefficient (μ₂) of the elastic body after removal of the surface treatment layer, the micro hardness values being determined by means of a micro hardness tester, satisfy the following relationships of formulas (1) and (2):
0<(Hs₁−Hs₂)/Hs₂17% (1)
and

|μ₁−μ₂/μ₂<22% (2).

2. A paper-sheet-feeding/conveying roller according to claim 1, wherein the elastic body is formed of a urethane material as a predominant component.

3. A paper-sheet-feeding/conveying roller according to claim 1, wherein the elastic body has an embossment.

4. A method for producing a paper-sheet-feeding/conveying roller, characterized in that the method comprises:
forming a surface treatment layer by impregnating a surface portion of an elastic body with a treatment liquid containing an isocyanate compound and curing the liquid,
so that the surface treatment layer has a micro hardness (Hs₁) of the surface treatment layer, the friction coefficient (μ₁) of the surface treatment layer, the micro hardness (Hs₂) of the elastic body after removal of the surface treatment layer, and the friction coefficient (μ₂) of the elastic body after removal of the surface treatment layer, the micro hardness values being determined by means of a micro hardness tester, which satisfy the following relationships of formulas (1) and (2):
0<(Hs₁−Hs₂)/Hs₂17% (1)
and

|μ₁−μ₂|/μ₂<22% (2).

5. A paper-sheet-feeding/conveying roller production method according to claim 4, wherein a liquid containing an isocyanate compound in an amount of 2.5 mass % to 12.5 mass % is used as the treatment liquid.

6. A paper-sheet-feeding/conveying roller according to claim 2, wherein the elastic body has an embossment.
